(19) United States
(12) Patent Application Publication
(10) Pub. No.: US 2015/0086366 A1
(43) Pub. Date: Mar. 26, 2015

(54) Wind turbine blade and blade hub

(71) Applicant: Robert Jeffrey Barnes, (US)

(72) Inventors: Robert Jeffrey Barnes, New Berlin, WI (US); Karen Lynn Barnes, New Berlin, WI (US)

(21) Appl. No.: 13/998,028

(22) Filed: Sep. 24, 2013

(51) Int. Cl. F03D 1/06

(52) U.S. Cl. CPC F03D 1/06
USPC 416/132 B

(57) ABSTRACT

Four blade VERTICAL AXIS WIND TURBINE is disclosed. Four equally radially spaced fixed troposkein shaped rotor blades nearly eliminates rotor torque ripple. Reduced rotor torque ripple allows thinner skin hollow cross section blades that are lighter and have higher frequency and lower stress natural vibrations. Improved single length blade extrusion has two integral mounting flanges at each of two root ends. One blade root flange is adjoined to the blade nose tip through a blade skin thickening gusset rail. One blade root flange is adjoined to the blade tail tip through a second blade skin thickening gusset rail. A third blade root flange forms a largely rectangular hollow between the two mounting flanges and the blade skin.

A separable rectangular cross section blade hub is made from two hollow rectangular L-shaped cross section extruded beams. These L-shaped beams are cut from a single extrusion.

### CROSS REFERENCE TO RELATED APPLICATIONS

Not Applicable:

### STATEMENT REGARDING FEDERALLY SPONSORED RESEARCH OR DEVELOPMENT

Not Applicable:

### SEQUENCE LISTING

Not Applicable:

### BACKGROUND OF THE INVENTION

1. Field of the Invention

This invention relates to vertical axis wind turbines which are used to convert wind energy.

2. Description of the Related Art

The Darrieus-type vertical axis wind turbine (VAWT) having its rotating shaft traverse to the air stream, was patented by G. M. Darrieus in the United States in 1931, U.S. Pat. No. 1,835,018. The Darrieus-type vertical axis wind turbine is said to resemble an egg-beater with curved blades connected at both ends to the ends of the rotating shaft. Each blade of the turbine is symmetrical in cross section and is bent along the blade length to approximate the shape a perfectly flexible cable would assume when spun around a vertical axis. This bent blade length shape is represented by the Greek word “troposkein” meaning turning rope. Troposkein shaped VAWT blades have centrifugal stress largely in tension when the rotor is spinning. Thus rotation of the VAWT rotor will not cause the blades to bend significantly beyond the troposkein shape, nor produce significant blade bending stresses.

The operational principal of the vertical axis wind turbine (VAWT) is analogous to the aerodynamics of a wing (airfoil) as is described in “THE WIND POWER BOOK” pages 78 and 79 by Jack Park. Wind forces on the blades of the VAWT are divided into lift and drag components. The lift force vector is perpendicular to the relative wind vector. The relative wind vector only develops when the outer blade nose moves faster than the ambient wind vector. This defines a “tip speed ratio” greater than one. The “tip speed ratio” is defined as the speed of the blade nose, furthest from the axis of rotation, divided by the ambient wind speed. The relative wind vector direction and speed changes continuously with the blade position on the rotation circle. The changing nature of the relative wind vector results in a positive power conversion efficiency curve plotted with respect to tip speed ratio, for ratios between 1.5 and 9. Therefore a motor must be used to start the turbine rotating.

Interest in the Darrieus-type VAWT has been stimulated in recent years by the energy crisis with important advantages for these turbines over horizontal axis turbines which include the following: (1) The VAWT accepts wind from all directions and therefore does not require costly wind direction orientating equipment. (2) The VAWT does not require adjustment of blade pitch to limit maximum power conversion at high wind speeds. (3) The generator, speed reducer and rotor brake do not have to be supported high above the ground as part of a wind orientating platform. (4) The VAWT blades are supported at both ends which makes for less expensive and longer lasting blades.

VAWT designs have advanced and have inherent advantages over horizontal axis turbines. But a VAWT is needed to be more cost effective in manufacture, erection, maintenance and operation.

Inventors have made attempts to create a VAWT that will prosper with the stable energy prices following the panic of 1973.

U.S. Pat. No. 6,364,609 to Barnes discloses a VAWT having both an erection gin pole and a combination hold down and stabilizing gin pole that allows a controlled pivot erection using a ground mounted cable winch. These gin poles provide tension reduction and rotor alignment for the three upper bearing guy cables that hold the turbine together during pivot erection. Controlled pivot erection of a VAWT with a ground mounted winch eliminates the need for an expensive tall crane. Several test VAWTs were designed, built and tested for the Wind Energy Research Division of Sandia National Laboratories from 1974 through 1992. The 34-Meter Test Bed was the most advanced VAWT designed, built and tested by the Wind Energy Research Division and commissioned at Bushland, Tex. in 1988. The 34-Meter Test Bed had 57 strain gage signals from the two rotor blades, 13 strain signals from the rotor tower, 8 strain signals from the brakes, 5 crack propagation signals, 25 environmental signals, 22 turbine performance signals, and 29 electrical performance signals. The two rotor blades were each 179 feet long, with a rotor equatorial diameter of 111.6 feet (34 meters). The 34-Meter Test Bed had a 500 Kilowatt power rating. The 34-Meter Test Bed also represented the anxiety of the 1980s, “to build it big”, with the most exclusive (expensive) equipment and manufacturing techniques. Sandia Laboratories report SAND-84-1287 FIG. 8 shows the 34-Meter VAWT rotor lower blade connection to the hollow circular cylindrical tower end. Note that the hollow cylindrical 34-Meter rotor tower is formed from one half inch thick aluminum plates and welded to a ten foot outside diameter.

SAND-84-1287 FIG. 8 also shows the cross section of the hollow blade end with a 48 inch chord length nose to tail and the two piece blade clamp. SAND-84-1287 FIG. 8 also shows a hollow rectangular cross section hub beam that connects the two lower blade ends to the lower circular tower end through a 10 foot diameter circular connection plate. SAND-84-1287 FIG. 8 also suggests four triangle shaped gusset plates welded to both the rectangular hub beam and the circular connection plate to stabilize the blade to tower connection. These triangular gussets supports 60 percent of the 10 foot diameter rotor tower. SAND-84-1287 FIG. 8 also shows two blade angle plates that connect the outside edges of the 48 inch blade end clamps to the rectangular hub beam walls.

Sandia Laboratories report SAND78-0577 “Torque Ripple in a Vertical Axis Wind Turbine” FIG. 3 shows that two blade VAWT rotors have torque ripple with two peaks per revolution. Two blade VAWT rotors have torque ripple that drives significant rotor blade and rotor tower vibration stresses especially one, two and three vibrations per rotor revolution, shown in Sandia Labs. report SAND91-2228 FIGS. 5.5, 5.6, 5.11, 5.12, 5.20, 5.21, 5.24 and 5.25. Sandia Labs. report SAND90 1615-UC-261 page 29 describes VAWT rotor stresses caused by two blade torque ripple. Two blade VAWT rotor torque ripple causes the blades to flap similar to a butterfly. Sandia Labs, report SAND90-1615-UC-261 page 42 shows 17 two blade rotor vibration mode shapes. Two blade VAWT torque ripple drives upper bearing cable vibration stress. Sandia Labs. report SAND90-1615-UC-261 pages 107 and 108 shows guy cable vibration stresses driven by two blade VAWT torque ripple.

The 34-Meter Test Bed had a rotor designed to withstand the vibration stresses driven by two blade VAWT torque ripple. This VAWT blade design was described as “tailored” or “step tapered”. The 34-Meter Test Bed blades have 48 inch chord length sections at both hub ends averaging 30 feet in length. The 34 Meter blades have a 36 inch chord length section that runs 62.6 feet in the blade center length. These two VAWT blades have two 24.6 foot sections with a 42 inch chord width that connects the 48 inch chord to the 36 inch chord. The larger the chord dimension the greater the blade thickness of 21 or 18 percent of the chord dimension. The 48 and 42 inch chord sections greatly stiffen the blades to vibration.

VAWT aerodynamic torque ripple magnitude is greatly reduced for rotors with four blades. This torque ripple reduction occurs with better relative wind vector to blade chord angles during rotor rotation. Four blade VAWT rotors reduce aerodynamic torque ripple and therefore reduces rotor blade, tower and upper bearing guy cable vibration stress. This four blade VAWT rotor torque ripple vibration reduction will make VAWT rotor blades, blade hubs and towers last longer. What is needed to lower the amortized cost of wind energy conversion, is a pivot erection VAWT with a cost effective four blade rotor. This cost effective four blade VAWT rotor will have lower first cost rotor blades, blade hubs and tower that have cost effective assembly and operate safely over more years than present wind turbines.

Sandia Labs, did build and test a three blade VAWT with a 17 meter (56 foot) maximum diameter rotor. Sandia Labs. also built and tested a 17 meter diameter rotor with two blades. The blades used on these 17 meter VAWTs had identical cross sections. At 52.5 RPM, the 3 blade VAWT converted 29 percent more power than the 2 blade VAWT in winds over 28 miles per hour. This extra wind energy conversion for a 3 blade VAWT over a 2 blade VAWT, with the same rotor sweep area, shows that a 3 blade VAWT is cost effective. Sandia Labs. report SAND78-1737 page 53 shows 2 blade 17 meter power data at 52.5 RPM in winds 4.5 to 40.5 miles per hour. Sandia Labs report SAND79-1753 page 39 shows 3 blade 17 meter power data at 52.5 RPM in winds from 2.5 to 41.5 miles per hour.

Further comparison of the 2 blade and 3 blade 17 meter power data at 52.5 RPM shows 3 blade power is not positive for wind speeds below 13.5 miles per hour. The 2 blade 17 meter rotor at 52.5 RPM has positive power for wind speeds above 9.5 miles per hour. This missing low speed wind power for the 3 blade 17 meter rotor can be corrected at 37 RPM as seen on page 15 of report SAND79-1753. The 34-Meter Test Bed had three speeds 28 RPM, 34 RPM and 38 RPM. The 17 meter rotor equivalent speeds would be 56 RPM, 68 RPM, and 76 RPM.

Two speed VAWT operation can be obtained by field weakening the popular shunt wound direct current motor-generator. D.C. shunt wound generator speed is lowest at rated field current for a desired armature voltage. At lower field current the D.C. shunt generator speed is higher for the same armature voltage. A carefully sized external power resistor can be connected to the shunt field winding for reduced field current and shorted by contactor for stronger field operation. Strong generator field and low rotor speeds could be used for low and extremely high winds. Weak generator field and higher rotor speeds could be used in intermediate wind speeds. Direct current windmills can drive direct current motors for vacuum pumps and heaters for water distillation. Direct current is used in water electrolysis to store energy in hydrogen gas.

“THE WIND POWER BOOK” page 77 shows a five straight blade VAWT with adjustable blade pitch. This picture shows that VAWTs with more than 3 blades produce power. Unlike Darrieus VAWTs, straight VAWT rotor blades will bend and fail with rotor overspeed in high winds.

### BRIEF SUMMARY OF THE INVENTION

In accordance with the present invention a Darrieus-type vertical axis wind turbine (VAWT) assembly is connected by a hinge to a ground embedded anchor. The turbine assembly includes a hinge connected support structure. This support structure includes a rotor lower bearing, an erection gin pole and a combined hold down and stabilizing gin pole. The turbine

assembly also includes a four blade rotor which is supported by the lower rotor bearing and the rotor upper bearing assembly, in every pivot position from horizontal to vertical. The support structure supports an electrical generator which is connected to the four blade rotor. The electrical generator produces electrical energy upon rotation of the turbine rotor. The turbine assembly upper rotor bearing assembly includes the attached ends of three guy cables. One upper bearing assembly guy cable end is strung over the end the erection gin pole and attached to a ground mounted winch. The other two upper bearing guy cables ends are each strung over opposite ends of the support structure combined hold down and stabilizing gin pole and attached to end of the structure opposite the stabilizing gin pole.

The turbine assembly four blade rotor consists of one hollow circular cylindrical aluminum alloy tower, four single length aluminum alloy blade extrusions and four stackable blade hubs. The aluminum blade extrusions include two integral hub bolting flanges at both nose and tail sections of the blade. The stackable blade hub assemblies consists of two interlocking L-shaped cross section beams. These hub beams have a hollow rectangular cross section which make them stackable. Each L-shaped blade hub beam has one central main web beam, when interlocked provides four areas of stress surface on the rotor tower end for stability. The interlocking L-shaped hub beams have hollow sections and are cut from a single aluminum alloy extrusion.

The four stackable blade hubs allows equal circumferential spacing between the nose edges of the four blade assemblies on the VAWT rotor. This equal circumferential blade spacing greatly reduces torque ripple driven vibration stresses in the four rotor blades, tower and the rotor upper bearing guy cables. This four blade rotor vibration stress reduction allows for lighter hollow blade sections and lower centrifugal blade forces in the remote chance of rotor speed runaway. The lighter hollow blade sections would be cheaper and result in higher less stressful blade deflection vibration frequencies and allow operation over more years than existing wind turbines.

The objects and advantages of this invention are:

A. To provide a vertical axis wind turbine with improved overall energy conversion cost effectiveness, particularly manufacturing, installation and operating costs.
B. This cost effective VAWT must survive high winds while in a fully installed condition.
C. To provide a cost effective VAWT design with practical commercial and industrial power conversion ratings.
1. The first advantage of this invention is pivot erection with upper bearing guy cables. Pivot erection installation eliminates the use of an expensive tall crane.
2. A VAWT four blade rotor that greatly reduces vibration stress in the rotor blades, rotor hubs, rotor tower and upper bearing guy cables. Reduced rotor vibration stress allows lighter weight rotor blades, blade hubs and rotor towers with longer operating life.
3. A VAWT rotor that uses only two custom aluminum extrusions. One custom aluminum alloy blade extrusion having a 53 or 65 foot length that eliminates expensive extension joints. Integral blade mounting flanges with connecting gusset rails in the blade root ends allows thinner hollow aerodynamic cross section and higher less stressful vibration frequencies. One hollow L-shaped rectangular cross section aluminum alloy extrusion, that can be cut to form an isosceles trapezoid shaped hub from two overlapping pieces.
4. Middle length blade braces allows high cross wind survivability while parked in an operating position.
5. The 4, 53 foot long blade VAWT rotor having a 75 horsepower maximum power conversion rating.
6. A 100 HP. 4 blade VAWT rotor with single length 65 foot blades. 65 foot blades would be shipped as over the tractor loads.

### BRIEF DESCRIPTION OF THE DRAWINGS

FIG. 1 A plan side view of the four blade rotor lower tower end attached to a four blade hub stack with one cut away inside blade end attached.

FIG. 2 A plan end view of separated blade hub beams.

FIG. 3 A plan side view of the four blade rotor tower end attached to the inside lower blade hub. The end of the lower inside blade hub is shown without a blade end attached.

FIG. 4 A plan side view of a blade hub beam extrusion with three cut lines.

FIG. 5 A plan side view of a blade extrusion end section.

FIG. 6 A cross section view of a blade extrusion end section.

FIG. 7 A plan side view of a pivot erection VAWT support structure, support structure anchor and rotation stop jack.

### DETAILED DESCRIPTION OF THE INVENTION

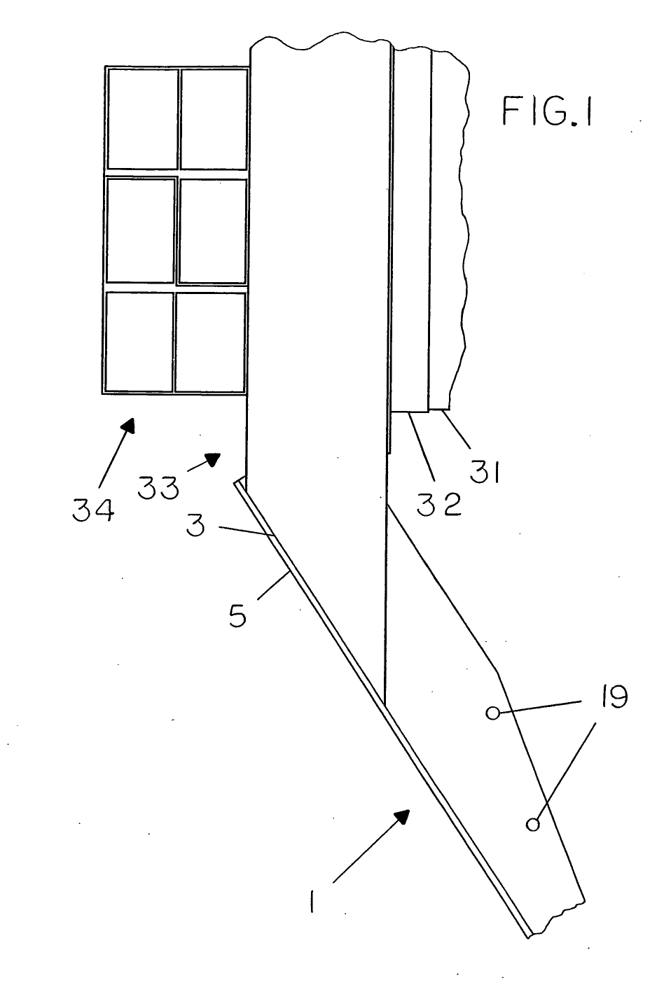

FIG. 1 shows a side view of a four blade 75 horsepower VAWT rotor lower blade hub stack. Inside lower hub assembly 33 is shown in FIG. 1. Inside blade extrusion 1 is shown mounted to inside hub assembly 33 in FIG. 1. Inside hub assembly 33 is cut off for the hub end opposite blade extrusion 1. The side of the hollow cylindrical rotor tower 31 is shown mounted to inside hub 33 by 2 flange ring 32 in FIG. 1. Tower. 31 is bolted to one flange of ring 32. Hub 33 is bolted to the other flange of ring 32. The bolts for 2 flange ring 32 are not shown. Tower 31 and 2 flange ring 32 are shown cut off with a jagged line. The hollow end of outside lower rotor hub assembly 34 is shown attached to inside rotor hub assembly 33 in FIG. 1. Blade extrusion 1 tail edge 3 is shown in FIG. 1. Blade extrusion 1 outside peak curve line 5 is shown in FIG. 1. Blade extrusion 1 vibration tuning holes 19 are shown in FIG. 1. The center of the length of rotor tower 31 is off the right edge of FIG. 1.

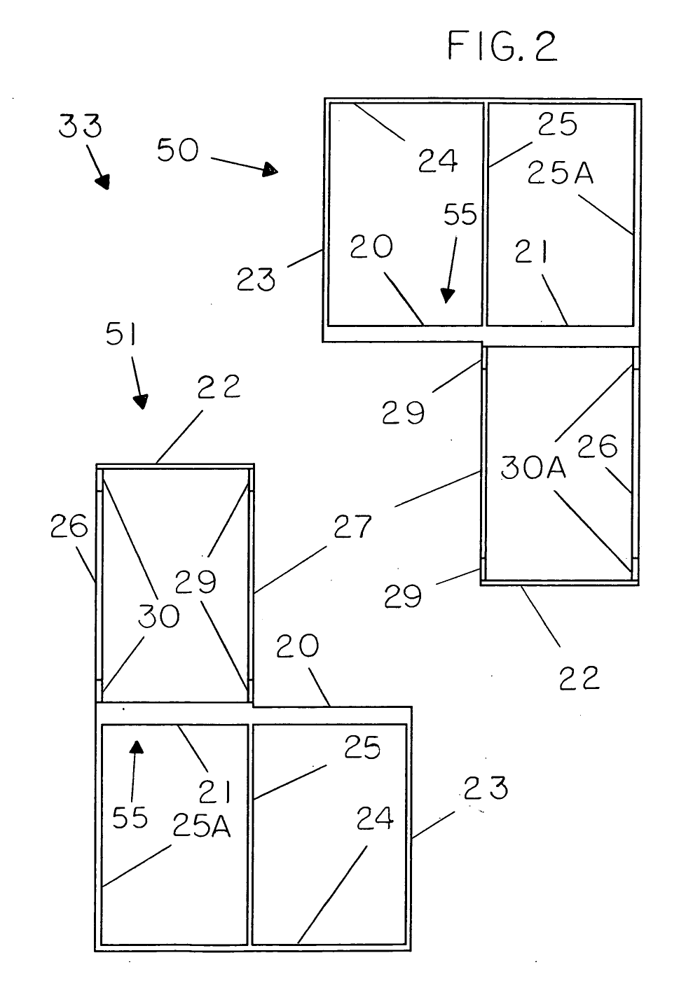

FIG. 2 shows a view of the hollow rectangular end of inside hub assembly 33. FIG. 2 shows inside hub 33 separated into the hollow L-shaped cross section hub beams 50 and 51. Beams 50 and 51 are cut from the same hollow extrusion 52. This hollow L-shaped cross section is composed of two hollow rectangles. Each beam has a central rotor blade mounting web 55 composed of sections 20 and 21 that extend into the drawing page. Web faces of sections 20 and 21 are in the same flat plane or are parallel to the same flat plane. Webs 23, 24, 25A and blade mounting web 55 make the sides of the larger hollow outside rectangle. Web 25 minimizes any column buckling in web 24. Note that the faces of webs 26, 22, and 55 are parallel to the rotor tower central axis and vertical in the operating position. Webs 22, 26, 27 and section 21 of blade mounting web 55 make the sides of the smaller inside hollow rectangle for either hub beam 50 or 51. All web faces in FIG. 2 extend into the drawing page and are perpendicular to it. The faces of webs 25A and 26 are in the same two flat planes.

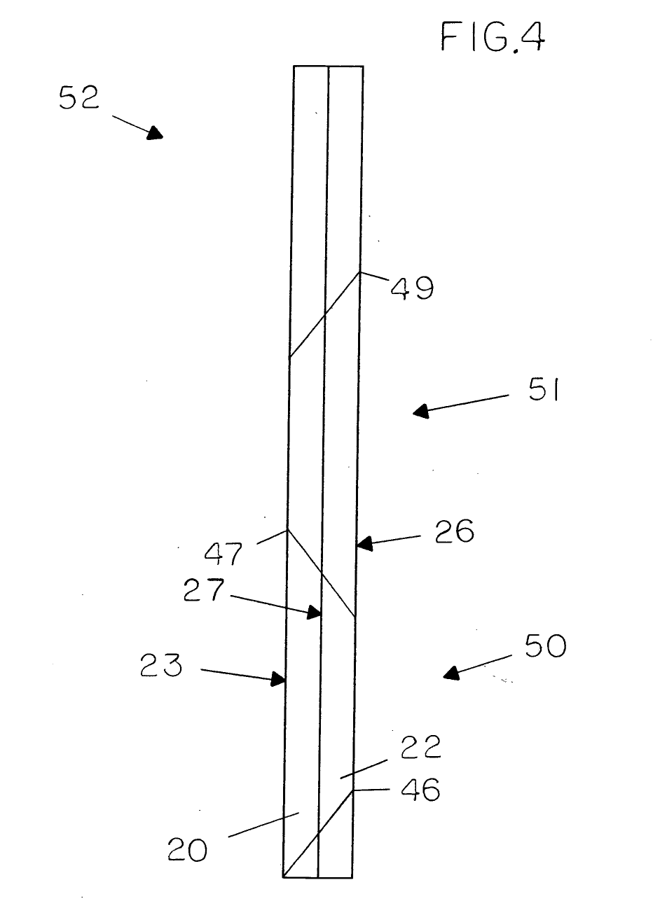

In FIG. 2 visualizing beam 51 webs 25A and 26 extending into the drawing page further than the same webs in beam 50 helps define the isosceles trapezoids shown in FIG. 4.

The 90 degree internal corners where the webs in FIG. 2 meet do not show stress distribution radii. Stress distribution radii at the web joint corners would be used in an actual hub beam extrusion. The short lines that cross webs 26 and 27 indicate corner edges for blade extrusion mounting flange slots 30 and 29 respectively on hub beam 51. Blade mounting flange slots 30A have the least depth into the page on web 26 of beam 50.

The difference between hub assembly 33 beams 50 and 51 can best be seen by comparing FIG. 2 with FIG. 4. FIG. 4 shows the side view of a hub beam extrusion 52. In FIG. 4 the surfaces of blade mounting beam web section 20 and web 22 can be seen. The long lines in FIG. 4 indicate the external 90 degree corners between web 23 and web section 20, web 27 and web 22, also web 22 and web 26, from left to right. These lines not only represent the external corners but also the web surfaces that extend into and are perpendicular to the drawing page. The arrow heads on the lead lines for element numbers 23, 27 and 26 indicate these web surfaces. Lines 46, 47 and 49 are the lines cut across the depth of hub beam extrusion 52. In FIG. 4 surface 22 is closer to the reader than surface 20. Hub beam 51 is rotated around corner line 27 so that the longer surface 26 of beam 51 to align with the longer surface 23 of hub beam 50. In FIG. 4 cut lines 46, 47 and 49 make the same angles with surfaces 23 and 26 creating matching isosceles trapezoids.

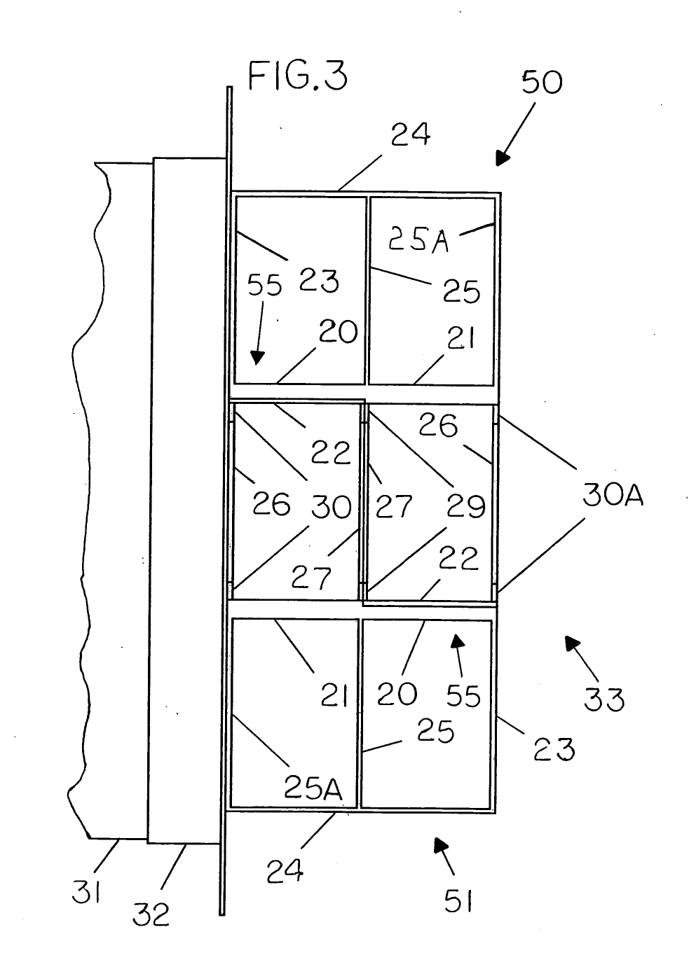

FIG. 3 shows inside blade hub assembly 33 reassembled from FIG. 2 with all the web element numbers 20 through 27 for both hub beams 50 and 51. Note hub assembly 33 cross section is a continuous rectangle because web 22 is half the length of web 24 for both hub beams 50 and 51.

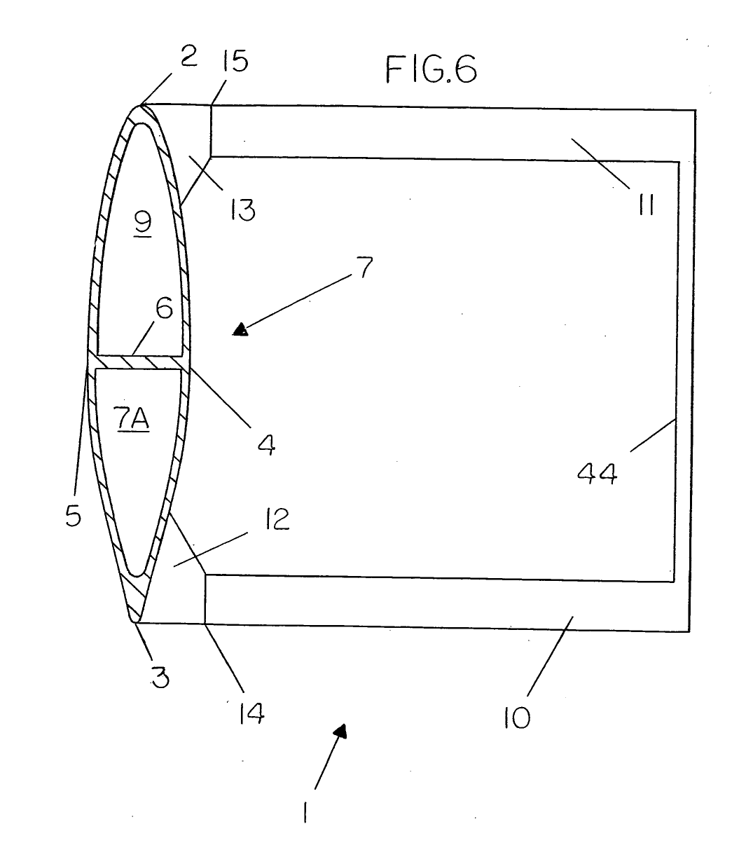

FIG. 3 also shows a complete side view of two flange ring 32. FIG. 3 also shows the cutoff lower end of hollow circular cylindrical rotor tower 31. In FIG. 3 the length center of rotor tower 31 is off the left edge of this drawing. FIG. 3 shows the blade extrusion 1 mounting flange clearance slots 29, 30 and 30A. Slots 30 extend into the drawing page and are cut into the edge of web 26 of hub beam 51. Web 26 slots 30 extend deeper into the drawing page than slots 30A. This mounting flange slot depth difference can be visualized in FIG. 1. Slots 30A are cut into web 26 of hub beam 50. Flange clearance slots 29 are cut to the same depth as slots 30A in web 27 in for both hub beams 51 and 50. FIG. 3 shows the two blade flange mounting beams consisting of web sections 20, 21 and web 22. Comparison of FIG. 3 with FIG. 6 helps visualize rotor blade extrusion 1 mounting flanges 10 and 11 fit between the two blade flange mounting beams composed of web 55 sections 20, 21 and web 22.

FIG. 3 also shows how the extra thickness of web section 21 supports the thickness of web 22 as the blades bend the mounting beams over the end of cylindrical tower 31. FIG. 3 shows how the notch created by the web thickness difference between web section 20 and 21 keeps the faces of webs 23, 25A and 26 in the same plane. FIG. 3 also helps visualize the four areas of stress on the end of the hollow cylindrical tower 31 from the blade flange mounting beams. Comparison of FIG. 1 with FIG. 3 shows how the inner blade hub 33 blade mounting beams have bending stress from the inner blade ends and compressive stresses from the outer blades. Web section 20 must be thick enough to withstand these combined stresses.

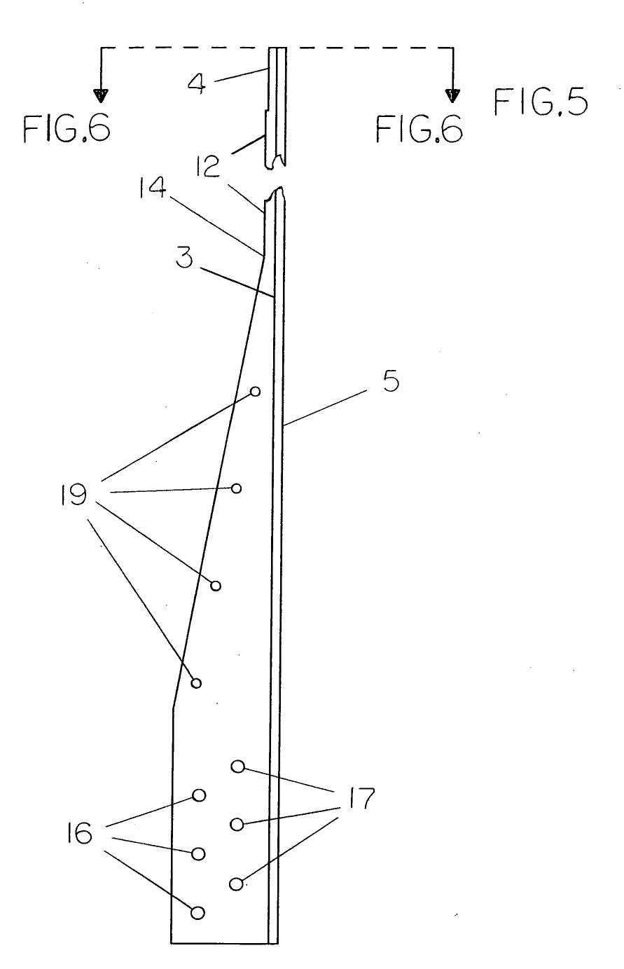

FIG. 5 shows a complete side view of one of the two blade root ends of blade extrusion 1. The side of blade tail mounting flange 10 with three inside circular blade flange mounting holes 16 and three outside circular blade flange mounting holes 17. The inside blade mounting holes 16 are mounted closer to the length center of tower 31. The inside blade hubs are also closer to the length center of tower 31. These inside and outside blade flange mounting holes have staggered spacing shown in FIG. 5. Outside blade flange mounting holes 17 are spaced further from the end edge of the tail blade mounting flange compared to inside mounting holes 16. This greater hole 17 spacing minimizes stress cracks in the matching mounting holes in hub beam web sections 20, 21 and 22 in hub beams 50 and 51. Blade flange mounting holes 16 and 17 also exist with the same spacing on blade nose mounting flange 11, which is better visualized in FIG. 6.

FIG. 5 line 5 represents the peak outside curve of the aerodynamic elliptic blade better seen in FIG. 6. FIG. 5 line 3 represents the blade tail curve tip better seen in FIG. 6. Line 4 in FIG. 5 represents the peak of the inside curve of the aerodynamic elliptic blade better seen in FIG. 6. Corner 14 represents the end of the tail mounting flange better seen in FIG. 6. Lines 3 and 5 are interrupted near the top of FIG. 5. shows that tail gusset rail 12 has more length than shown. FIG. 5 also shows the cross section view direction for FIG. 6 with the dashed line and arrow heads at the top of the drawing page. Blade flatwise vibration tuning holes 19 are shown in tail mounting flange 10 in FIG. 5. Tuning holes 19 have aligning holes in blade nose mounting flange 11 best visualized viewing FIG. 6. Tuning holes 19 are used with nuts bolts and bolt sleeve bushings to hold the spacing between blade mounting flanges 10 and 11 best seen in FIG. 6.

FIG. 6 shows the cross section of hollow aerodynamic elliptic blade 7. Hollow blade 7 skin support web 6 is also shown in FIG. 6. Blade 7 is part of aluminum alloy rotor blade extrusion 1. Hollow blade 7 skin and blade skin support web 6 have equally spaced hatch lines shown in FIG. 6. Hollow rotor blade 7 has a nose tip 2 and tail tip 3, also an inside peak thickness point 4 and peak outside thickness point 5. The inside blade 7 skin curve is closer to the rotor tower 31 length center best visualized in FIG. 1. The outside blade 7 skin is further from the rotor tower 31 length center than the blade 7 inside skin, best visualized in FIG. 1. FIG. 6 also shows blade 7 nose hollow 9 and tail hollow 7A.

Blade 7 skin and support web 6 are shown nearly 80 percent too thick for scale, to better see the hatch lines. The desired 75 or 100 horsepower four position rotor blade will be similar to the symmetrical NACA 66-021 profile with a chord length nose tip to tail tip of 10.5 inches. This 10.5 inch hollow blade 7 will have a skin thickness of 0.094 plus or minus 0.02 inches. Blade 7 maximum thickness between FIG. 6 points 4 and 5 will be at least 21 percent of the chord line between FIG. 6 points 2 and 3, approximately 2.2 inches.

Extrusion 1 includes integral blade nose mounting flange 11 and blade tail mounting flange 10 as shown in FIG. 6. Blade mounting flange support web 44 is also shown in FIG. 6. Support web 44 greatly reduces cantilever torque from either blade mounting flange onto the skin of hollow blade 7. This cantilever blade skin stress would otherwise occur due to tool pressure when cutting the circular bolt mounting holes 16 and 17 in either blade mounting flange 10 and 11. Cantilever blade skin stress is also reduced when cutting circular vibration tuning holes 19.

FIG. 6 also shows blade nose skin stress distribution gusset rail 13. FIG. 6 also shows blade tail skin stress distribution gusset rail 12. Corner line 14 shows that tail mounting flange 10 does taper down to tail gusset rail 12. Corner line 15 shows that nose mounting flange 11 does taper down to gusset rail 13. All elements shown in FIG. 6 except corner lines 14 and 15 extend into the drawing page.

FIG. 6 shows gusset rails 13 and 12 make the hollow blade 7 inside skin much thicker near the mounting flanges 11 and 10. The outside face of nose flange 11 aligns with blade nose tip point 2. The outside face of tail flange 10 aligns with blade tail tip point 3. The thickness of both mounting flanges 10 and 11 is approximately 9.5 percent of the chord length between points 2 and 3 of FIG. 6 or 1 inch. Gusset rail 13 also makes mounting flange 11 thicker by up to 1.03 inches or 9.8 percent of the blade 7 chord line. Gusset rail 12 makes mounting flange 10 thicker by up to 1.2 inches or 11.5 percent of the 10.5 inch blade 7 chord line. Gusset rails 12 and 13 makes mounting flanges 10 and 11 and blade 7 inside skin thicker in the respective adjoining areas. The gusset rail 13 thickness tapers on a straight line from a point 1.39 inches above the blade 7 chord line and on the inside face of flange 11, down to the blade 7 skin. Gusset rail 13 extends into the drawing page. Gusset rail 12 thickness tapers on a straight line from a point 1.39 inches above the blade 7 chord line and on the inside face of flange 10 down to the blade 7 skin. Gusset rail 12 extends into the drawing page. There is significant bending stresses due to blade vibration absorbed by gusset rails 13 and 12. There is also significant tensile stress in the blade extrusion gussets and mounting flanges due to centrifugal force, especially during rotor overspeed.

Comparing FIG. 5 and FIG. 6 blade extrusion 1 mounting flanges 10, 11 and web 44 and portions of gusset rails 12 and 13 can be taken off most of the blade length using a sliding gate on the extrusion die. The output of the extrusion die is where the aluminum alloy is a hot soft jelly. Portions of blade extrusion 1 gussets 12 and 13 will have to be machined off and belt sanded to obtained the smooth elliptic curve of hollow blade 7, after extrusion 1 has cooled. Cold cutting of gussets 12 and 13 allows for a thinner blade 7 skin. FIG. 6 also shows that the blade 7 outer skin requires no cutting or sanding to remove flanges 10, 11 and gussets 12 and 13. Eliminating machining or sanding of blade 7 outside skin is obtained by the offset of blade mounting flanges 10 and 11 to the inside of the blade chord line. This mounting flange offset reduces the rotor manufacturing cost.

A comparison of FIG. 1, FIG. 3 and FIG. 6 will show that blade extrusion mounting flanges 10 and 11 fit into flange slots 30A, 29 and 30 of hub assembly 33 in FIG. 3. FIG. 3 also shows that the width of hub beam webs 26 and 27 must be slightly wider than the chord line imagined between FIG. 6 points 2 and 3. Further review of FIG. 5 and FIG. 3 suggests that blade extrusion mounting holes 16 and 17 exist and align with holes of accommodating diameter in blade extrusion mounting flange 11. FIG. 1 also shows that blade extrusion mounting holes must be drilled in hub beam webs 20, 21 and 22 to align with both the cut line of beams 50 and 51 but also the mounting hole spacing shown in FIG. 5.

Further comparison of FIG. 1 and FIG. 3 will show that lower hub assemblies 33 and 34 are very similar except for the blade extrusion mounting angle and their mounting to tower 31. Comparing FIG. 1 and FIG. 3 shows that the web 24 faces of hub 33 lie in parallel planes that are perpendicular to the web 24 faces of hub 34. FIG. 3 shows that the web 24 faces of hub 33 are equidistant from the cylindrical axis of tower 31. Note also that the web 24 faces of the upper inside blade hub must lie in the same plane as the nearest inside blade hub 33 web 24 face. Also the web 24 faces of the upper outside blade hub must lie in the same plane as the nearest web face 24 of blade hub 34.

A single aluminum alloy blade extrusion 1 using either a gated die or cold machining eliminates the need to weld mounting flanges to the hollow blade. Welding aluminum alloy pieces together significantly reduces the temper strength by 40 percent near the weld. Extruding the blade mounting flanges and gussets rails as part of the blade extrusion allows a thinner hollow 7 skin. Exceptional control of welding heat is needed to avoid cratering of the hollow skin.

Sandia Labs report SAND-84-1287 final design option 2 reports that the 111.8 feet of equatorial length of the 34 meter test bed has skin and internal webs 0.25 inches thick. 0.094 inch skin thickness is 38 percent of the 34 meter skin thickness. Report SAND-84-1287 also reports that the two 24.6 foot transition section with the 42 inch chord has skin and web thickness of 0.25 inches. Report SAND-84-1287 reports the 34 meter hub sections with a 48 inch chord has skin and web thicknesses of 0.31 inches. The 34 meter hub sections have 21% of chord maximum thickness or 10.1 inches.

FIG. 6 shows by scale the width of mounting flanges 10 and 11 that clears the gusset rails 12 and 13 to be 9.5 inches. This mounting flange width for 65 foot long is 94% of the 34 meter hub section thickness for a 179 foot length. FIG. 6 shows by scale the maximum thickness of gusset rails 12 and 13 to be 1.39 inches. This gusset rail thickness makes the hollow 7 skin very thick exactly where the tension and vibration stresses are transferred to the rotor hub. This 1.39 inch gusset thickness is 5.5 times thicker than the 34 meter equatorial skin thickness of 0.25 inches with no joint bolt holes.

Wind turbines have mechanical blades that experience wind forces that bend these blades. When the wind forces change due to rotation or turbulence these blades snap back and that starts vibration. Blade snap back or rigidity is a function of the material modulus of elasticity and cross section moment of inertia. Turbine blades of greater mass, for the same moment of inertia and length, vibrate at a lower frequency than lighter blades of the same material and moment of inertia. The moment of inertia for a hollow ellipse changes very little with skin thickness for the same cross section outline dimensions. Consequently thin skin, lighter hollow blades of the same length vibrate at higher frequencies than heavier hollow blades with the same cross section outline and comprised of the same material.

Sandia report SAND91-2228 FIGS. 5.5 and 5.6 shows that lighter VAWT blades with higher modal vibration frequencies are comparatively low stress. The 34 meter test bed blades were mounted to the rotor hubs using contoured clamp plates as shown in report SAND-84-1287 FIG. 8. This clamp pressure for the 34 meter turbine requires 0.31 inch skin and web thickness. The 34 meter turbine clamps allow for end movement due to flatwise vibration. The present invention end movement will be obtained by drilling assembly flange mounting holes 16 and 17 larger than the aligning mounting holes in the hub beams and mounting bolt shank diameters (not shown).

The present invention will include four blade braces between the tower 31 and the center length of each blade at the rotor equator. These four blade braces will have a blade 7 skin and partially thinned remains of gusset rails 12 and 13. The thicker brace skin at the remains of gusset rails 12 and 13 allows for the welding of a bolting plate at each end of these four blade-like blade braces. The blade brace bolting plates will have at least 60 percent of their total surface outside the elliptic brace cross section on both sides of the chord line. Each blade brace bolting plate face is perpendicular to the brace chord plane.

Each inside blade brace will be bolted tight to tower 31 by two bolts, one above the brace and one below. The blade brace length will allow for one 1 inch thick 3 inch outside diameter rubber hammer heads to fit between the brace bolting plate and the inside surface of the rotor blade. The outside blade brace bolts must be long enough to pass through the thickest section of the rotor blade, two 1 inch thick cylindrical rubber 3 inch diameter hammer heads and the brace bolting plate thickness. The blade brace bolt will pass through the center of the cylinder circle. The second hammer cylinder is a pad between the outside blade 7 skin and brace bolt head and washers. These four flexible hammer cylinders eliminates noise and metal to metal pounding as the blade bends while the rotor is parked in high winds.

An additional note is hub beam extrusion 52 and hub beams 50 and 51 cut from it have a seamless cross section. Blade mounting beam 55 sections 20 and 21 central planes are parallel to the tower 31 central axis a shown in FIG. 3. The major dimension of beam 55 is between hub beam webs 25A and 23. This beam 55 major dimension is multiplicatively cubed in computing the maximum beam flexure stress, because the mounting beam central plane is parallel to the tower 31 central axis. Beam 55 makes contact with tower 31 in two places and in a plane parallel to but separate from the tower 31 central axis. Inside blade hub 33 has four areas of tower 31 contact equal spaced from the tower central axis. The beam 55 major dimension will be approximately 14 inches. This spacing of the two beams 55 and the large flexure dimension eliminates the blade mounting webs shown in the blade hubs in FIGS. 6 and 8 in U.S. Pat. No. 6,364,609 and makes a lighter and stronger blade hub.

The blade extrusion 1 also has a seamless cross section. Mounting flange support web 44 in FIG. 6 is connected to and supports blade mounting flanges 10 and 11 separated from hollow blade 7 skin and gusset rails 12 and 13. Blade extrusion 1 includes all the elements shown in FIG. 6, 2, 3, 4, 5, 6, 7, 7A, 9, 10, 11, 12, 13, 14, 15 and 44. All these extrusion 1 elements are in the short length of the two blade end roots. Approximately 80 percent of the length of extrusion 1 consists of elements 2, 3, 4, 5, 6, 7A and 9 only. Elements 2, 3, 4, 5, 6, 7A and 9 describe the cross section of the hollow elliptic blade 7.

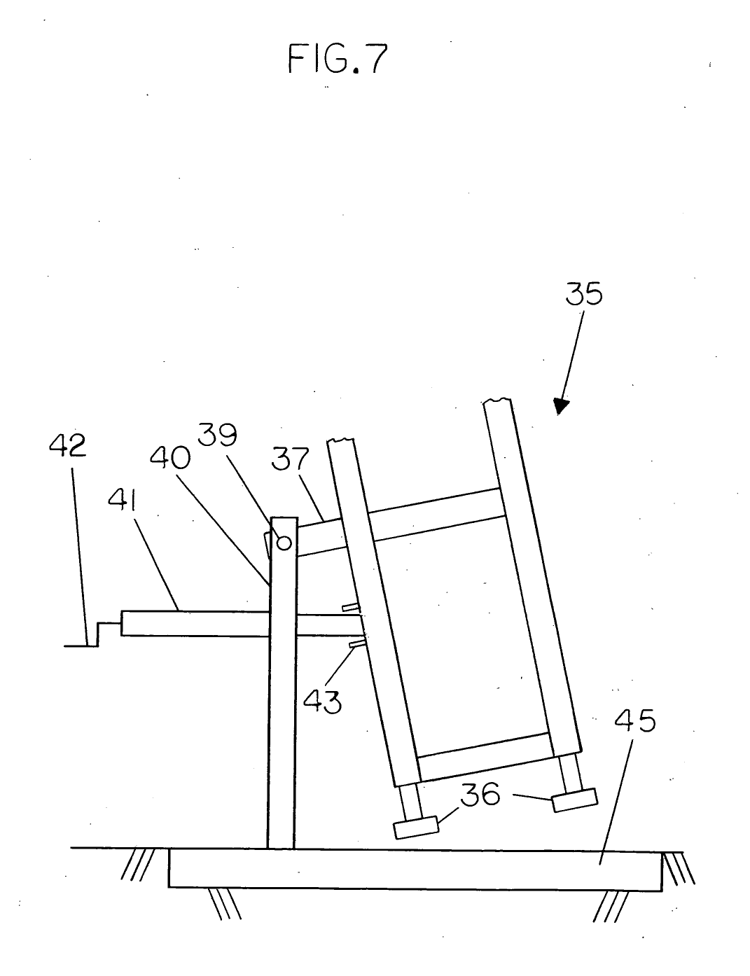

FIG. 7 shows a cut off side view of VAWT support structure 35 connected to VAWT support structure anchor 40 through pivot offset arm 37 and pivot pin 39. Pivot stop tube jack 41 is mounted to anchor frame 40 to extend on either side of anchor frame 40. Jack adjustment handle 42 appears in the lower left corner of FIG. 7. Jack handle 42 is turned one way to lengthen jack 41 to the right of anchor frame 40. Turning handle 42 the opposite way shortens jack 41 on the right side of frame 40. Jack 41 makes contact with support structure 35 u-channel beam 43 to stop the rotation of structure 35 around pivot pin 39. As jack 41 is shortened the longitudinal axis of structure 35 swings closer to parallel to the longitudinal axis of anchor frame 40. The longitudinal axis of frame 40 is embedded in concrete plate 45 to be parallel to the gravitational vector or vertical. FIG. 7 shows the longitudinal axis of anchor 40 is perpendicular to the surface of concrete plate 45 and the ground plane. Two of the four adjustable support bolts 36 are shown in FIG. 7. Support bolts 36 are adjusted to make contact with the top surface of plate 45 when structure 35 is parallel to frame 40. On a sloping ground plane the top surface of concrete plate 45 are not parallel to the ground plane. Support structure 35 supports the VAWT rotor through the lower spindle bearing not shown. U.S. Pat. No. 6,364,609 FIG. 2 shows a more complete side view of VAWT pivot erection without a pivot stop jack shown.

The full scope of the invention is shown in the following claims.

What is claimed is:

1. A Darrieus-type vertical axis wind turbine comprising:
a vertical tower supported for rotation;
one or more blades each connected to said tower causing rotation in response to wind energy therewith, wherein each blade has an upper root end connected to the top of said tower by a separable blade hub and a lower root end connected to the bottom of said tower by a separable blade hub.

2. A wind turbine as set forth in claim 1 wherein said blade hubs further comprise:
two hollow L-shaped rectangular cross section hub beams, said hub beams consists of one hollow inside rectangle and one hollow outside rectangle in one extrusion, said hollow inside rectangle having half the height of said hollow outside rectangle such that interlocking two beams produces one larger rectangular blade hub cross section, said hub beams each having one blade root mounting web, said blade root mounting web separating and being a web wall in each of said hub beam hollow rectangles, said blade hub cross section having two separated blade root mounting beams.

3. A wind turbine set forth in claim 1 wherein said blades further comprise:
a single extruded length with a hollow blade cross section having a nose tip and a tail tip;
said blade extrusion further comprising two integral blade end roots, said blade roots further comprising a nose mounting flange, said blade nose mounting flange having one face near the blade nose tip line, an integral blade tail mounting flange, said blade tail mounting flange having one face near the blade tail tip line, a nose gusset rail that thickens said hollow blade skin adjoining said blade nose mounting flange, a tail gusset rail that thickens said hollow blade skin adjoining said blade tail mounting flange, said blade end root further comprising a blade mounting flange support web connected to said blade mounting flange.
